(19) United States
(12) Patent Application Publication
(10) Pub. No.: US 2019/0180427 A1
(43) Pub. Date: Jun. 13, 2019

(54) DISPLAY APPARATUS AND METHOD OF CONTROLLING THE SAME

(71) Applicant: SAMSUNG ELECTRONICS CO., LTD., Suwon-si, Gyeonggi-do (KR)

(72) Inventors: Young-seok HAN, Yongin-si, Gyeonggi-do (KR); Jong-hwan KIM, Seoul (KR); Se-hyeok PARK, Seoul (KR)

(21) Appl. No.: 16/324,678

(22) PCT Filed: Jul. 25, 2017
(86) PCT No.: PCT/KR2017/008010

§ 371 Date: Feb. 11, 2019

(30) Foreign Application Priority Data
Sep. 9, 2016 (KR) 10-2016-0116507

(51) Int. Cl. G06T 5/20; G06T 3/00; G06T 3/40; H04N 5/232; H04N 13/117

(52) U.S. Cl. CPC G06T 5/20; G06T 3/0062; G06T 3/40; G06T 2207/20104; G06T 3/0093; G06T 3/4038; H04N 13/117; H04N 5/23238

(57) ABSTRACT

Disclosed is a display apparatus and a method of controlling the same. The display apparatus include an image receiver configured to receive an omnidirectional image; an image processor configured to perform an image process with regard to the received image; a display configured to display an image based on the image process; and a controller configured to control the image processor to perform a second image process for changing a characteristic of a certain area of the image and to perform a first image process for changing pixel density. Thus, there is provided a display apparatus and a method of controlling the same to perform an image processing to improve image quality without distortion or nonuniformity of an image.

### TECHNICAL FIELD

The disclosure relates to a display apparatus and a method of controlling the same, and more particularly to a display apparatus, which can perform an image process to prevent non-uniformity and improve an image, and a method of controlling the same.

### BACKGROUND ART

A recent display apparatus provides various images. A 360-degree image is one of them, which is based on technology that an omnidirectional image is captured by many cameras or a camera with a plurality of lenses and displayed on a screen as mapped to a virtual space so that a user can feel interaction as if s/he is in an actual space.

To provide the 360-degree image to a user, the display apparatus converts an area selected from a curved image by the user into a plane image, enlarges or reduces the displayed image, and performs an additional process for enhancing image quality.

Such an image process for geometrically transforming an image as enlarging or reducing an image, converting a curved image into a plane image, etc. will be called warping. The warping refers to a job for mapping a pixel at a certain position to that at a new position, by which an image is partially or totally changed in pixel density. The change in the pixel density causes change in a frequency characteristic of the image. For example, when an image is enlarged, the pixel density is decreased and thus the image has a low frequency characteristic. On the other hand, when an image is reduced, the pixel density is increased and thus the image has a high frequency characteristic. Further, when a curved image is converted into a plane image, the image has a high frequency characteristic due to high pixel density at the center but has a low frequency characteristic due to low pixel density at the edges.

However, when a filter for enhancing image quality is applied to an image that has already been subjected to the warping, an artifact may be magnified or a problem of nonuniformity may be caused in the image. For example, when a high-pass filter for improving sharpness is applied to an image having a low frequency characteristic, an artifact is magnified. Further, when a low-pass filter for reducing noise is applied to an image having a high frequency characteristic, it is difficult to get desired results because a signal component is treated as noise and removed, and so on. To solve these problems, a cut-off frequency of a filter may be changed for a frequency characteristic of an image, but there are difficulties because of problems of high costs, hardware limitations, etc.

### DISCLOSURE

### Technical Problem

To solve the foregoing problems, the disclosure provides a display apparatus and a method of controlling the same, in which image quality is improved without distortion or nonuniformity of an image when the image is changed in pixel density like a case of warping.

### Technical Solution

According to one aspect of the disclosure, there is provided a display apparatus including: an image receiver configured to receive an omnidirectional image; an image processor configured to perform an image process with regard to the received image; a display configured to display an image based on the image process; and a controller configured to control the image processor to perform a second image process for changing a characteristic of a certain area of the image and to perform a first image process for changing pixel density. Thus, image quality is improved without distortion or nonuniformity of an image.

The second image process may include a filtering process for one of a high frequency component and a low frequency component of the image, thereby giving an example of the second image process.

The controller may control the image processor to further perform a third image process for changing whole characteristics of the image subjected to the first image process, thereby changing the whole characteristics of the image without distortion due to area change.

The controller may control the image processor to select the certain area of the image based on the user input, thereby improving convenience for a user as an output image to a certain area is generated in response to a user's selection.

An input image may be generated using a plurality of images omnidirectionally obtained by a camera with at least one lens, thereby diversifying content as the images obtained in different orientations are used in providing content to a user.

The first image process may include a process for converting the plurality of images into a spherical image, thereby mapping a plurality of images into a spherical image.

The first image process may include a process for converting the spherical image into a plane image, thereby giving another example of the first image process.

The first image process may include a process for enlarging or reducing the certain area of the image, thereby giving still another example of the first image process.

According to another aspect of the disclosure, there is provided a method of controlling a display apparatus, the method including: receiving an omnidirectional image; performing an image process with regard to the received image; and displaying an image based on the image process, and the performing of the image process including: performing a second image process for changing a characteristic of a certain area of the image; and performing a first image process for changing pixel density after the second image process.

Thus, image quality is improved without distortion or nonuniformity of an image.

The second image process may include a filtering process for one of a high frequency component and a low frequency component of the image, thereby giving an example of the first image process.

The performing of the image process may further include performing a third image process for changing whole characteristics of the image subjected to the first image process, thereby more accurately changing the whole characteristics of the image as a third image process for changing the whole characteristics is performed after the second image process.

The method may further include receiving a user input; and selecting the certain area of the image base on the user input, thereby improving convenience for a user as an output image to a certain area is generated in response to a user's selection.

The method may further include generating an input image using a plurality of images omnidirectionally obtained by a camera with at least one lens, thereby diversifying content as the images obtained in different orientations are used in providing content to a user.

The first image process may include a process for converting the plurality of images into a spherical image, thereby mapping a plurality of images into a spherical image.

The first image process may include a process for converting the spherical image into a plane image, thereby giving an example of the first image process.

The first image process may include a process for enlarging or reducing the certain area of the image, thereby giving another example of the first image process.

### Advantageous Effects

As described above, according to the disclosure, image quality is improved without distortion or nonuniformity of an image when the image is changed in pixel density like a case of warping.

### DESCRIPTION OF DRAWINGS

FIG. 1 illustrates a display apparatus according to an embodiment of the disclosure.

FIG. 2 illustrates a process of processing an image obtained by a display apparatus according to an embodiment of the disclosure.

FIG. 3 is a block diagram of a display apparatus according to an embodiment of the disclosure.

FIG. 4 illustrates an example that pixel density is changed as a display apparatus according to an embodiment of the disclosure enlarges and reduces an image.

FIG. 5 illustrates an example that pixel density is partially changed as a display apparatus according to an embodiment of the disclosure converts a curved image into a plane image.

FIGS. 6 and 7 illustrate frequency characteristics of an image varied depending on an operation of a display apparatus according to the related art and an embodiment of the disclosure.

FIG. 8 illustrates an example of the whole characteristics of the display apparatus according to an embodiment of the disclosure.

FIG. 9 is a control flowchart of the display apparatus according to an embodiment of the disclosure.

### BEST MODE

Below, embodiments of the disclosure will be described in detail with reference to accompanying drawings. The following descriptions of the exemplary embodiments are made by referring to elements shown in the accompanying drawings, in which like numerals or symbols in the drawings refer to like elements having substantively the same functions.

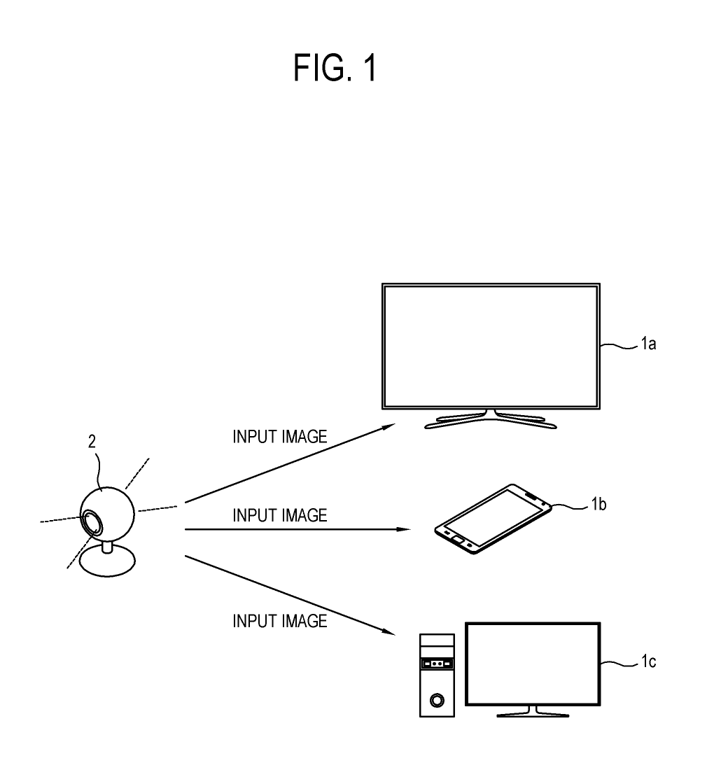

FIG. 1 illustrates a display apparatus according to an embodiment of the disclosure. The display apparatus 1a, 1b or 1c according to an embodiment of the disclosure may be actualized by a television (TV). According to another embodiment of the disclosure, the display apparatus 1a, 1b or 1c may be actualized by a smart phone, a tablet computer, a mobile phone, a computer, a multimedia player, an electronic frame, a digital billboard, a large format display (LFD), a signage, a set-top box, a smart watch, a wearable device such as a head-mounted display (HMD), a refrigerator, or the like apparatus capable of outputting an image. The display apparatus 1a, 1b or 1c in this embodiment displays an output image, which is obtained by processing an input image, on a screen. The input image in this embodiment may be generated using a plurality of images omnidirectionally obtained by a camera 2 with at least one lens, and the at least one lens may include a wide-angle lens as necessary. However, there are no limits to a means for generating an input image 100, and the input image 100 may include an image generated using a plurality of cameras. The display apparatus 1a, 1b or 1c may receive the input image from at least one camera 2, or may receive the input image through an external apparatus such as a server, a universal serial bus (USB) storage, a computer, etc. Alternatively, the display apparatus 1a, 1b or 1c may include at least one camera 2.

The display apparatus 1a, 1b or 1c in this embodiment performs a first image process with regard to a certain area of the received input image and generates an intermediate image. The display apparatus 1a, 1b or 1c performs a second image process with regard to the generated intermediate image, and displays the processed output image on a screen.

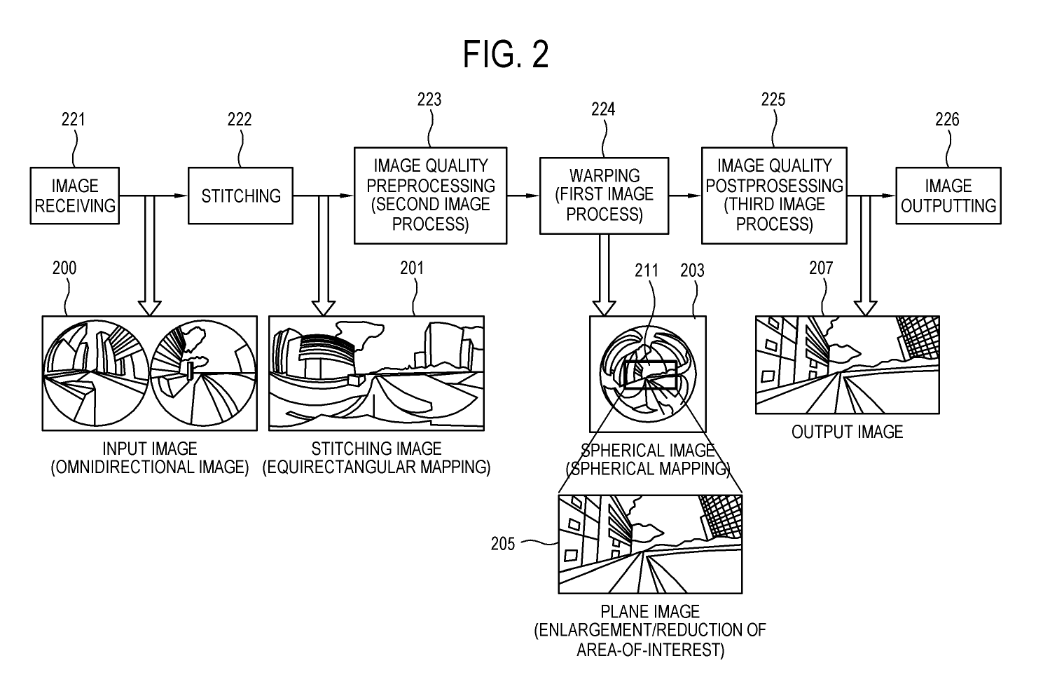

Below, a process that the display apparatus according to an embodiment of the disclosure displays the output image based on the input image will be described in detail with reference to FIG. 2. The display apparatus 1 receives an input image 200 including a plurality of images which are omnidirectionally obtained using the camera 2 including at least one lens (see ‘221’ in FIG. 2). The display apparatus 1 according to an embodiment of the disclosure may perform at least one image process with regard to the received input image 200. Specifically, the display apparatus 1 connects (or stitches; 222) the received input image 200 by equirectangular mapping based on, for example, a high dynamic range imaging (HDRI) map type, thereby generating a stitching image 201. According to an embodiment of the disclosure, the stitching image 201 is not limited to the HDRI map type, and may also be generated by mapping images obtained in six directions onto a regular hexahedron, i.e. a cube based on a cube map type.

The display apparatus 1 according to an embodiment of the disclosure performs image-quality preprocessing (see ‘223’ in FIG. 2) with regard to the stitching image 201. According to an embodiment of the disclosure, the image-quality preprocessing 223 is an example of the second image process for changing a characteristic of a certain area in an image. The change in the characteristic of the certain area in the image may include increment or decrement in a low frequency component or high frequency component of the image. The image-quality preprocessing 223 refers to a process for enhancing the image quality of the image, and may for example include image processes for improving the sharpness, removing noise, etc. The image-quality preprocessing 223 shown in FIG. 2 may include high-pass filtering for removing a low frequency component and amplifying a high frequency component in the stitching image 201 to improve the sharpness, or low-pass filtering for removing the high frequency component from the stitching image 201 to remove the noise. The embodiment shown in FIG. 2 shows an example of applying the image-quality preprocessing 223 to the stitching image 201, but the disclosure is not limited to this embodiment. Alternatively, the display apparatus 1 may perform the image-quality preprocessing with regard to the input image 200 before generating the stitching image 201.

Next, referring to FIG. 2, the display apparatus 1 performs warping 224 with regard to the image subjected to the image-quality preprocessing 223. According to an embodiment of the disclosure, the warping 224 is an example of the first image process for changing pixel density in an image according to the disclosure. For example, the warping 224 may include image processes for converting the image subjected to the image-quality preprocessing 223 into a spherical image (see ‘203’ in FIG. 2), enlarging or reducing a certain area of the spherical image 203, converting the spherical image 203 into a plane image (see ‘205’ in FIG. 2), etc. Specifically, the display apparatus 1 generates the spherical image 203 by spherically mapping the image subjected to the image-quality preprocessing 223. Next, the display apparatus 1 applies curved-to-plane mapping to a certain area 211 (hereinafter, referred to as an ‘area-of-interest’) of the spherical image 203, thereby generating the plane image 205. According to an embodiment of the disclosure, the area-of-interest 211 refers to a part of the spherical image 203, which will be displayed on a screen,

The selection of the area-of-interest 211 may be determined by a user. Specifically, the display apparatus may change the area-of-interest 211 according to viewpoints changed in response to a user's input for changing the viewpoint on the screen, while displaying the area-of-interest 211. Alternatively, the display apparatus may change the area-of-interest 211 according to enlargement or reduction in response to a user's input for enlarging or reducing the screen, while displaying the screen.

As described above, the display apparatus 1 according to an embodiment of the disclosure performs the image-quality preprocessing 223 before performing the warping 224. That is, the display apparatus 1 first performs the image-quality preprocessing 223 before performing the warping 224, in order to prevent an image from distortion or the like that may occur when the image quality process is performed after the warping 224. Below, process order of the image-quality preprocessing 223 and the warping 224 will be described in more detail according to an embodiment of the disclosure.

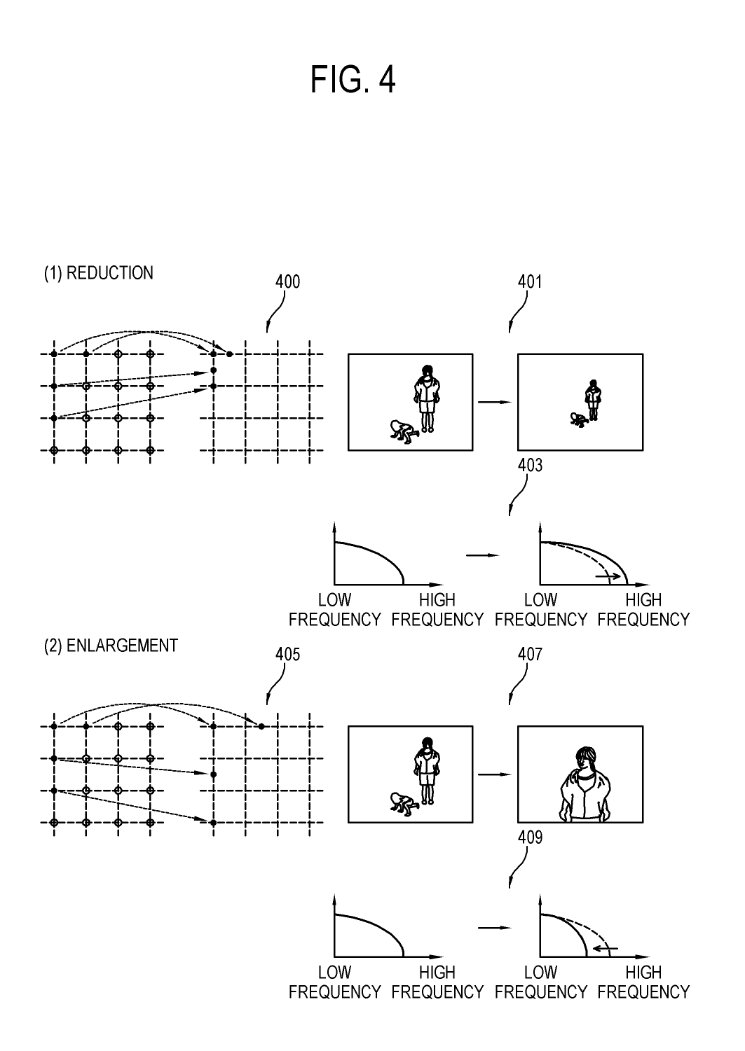

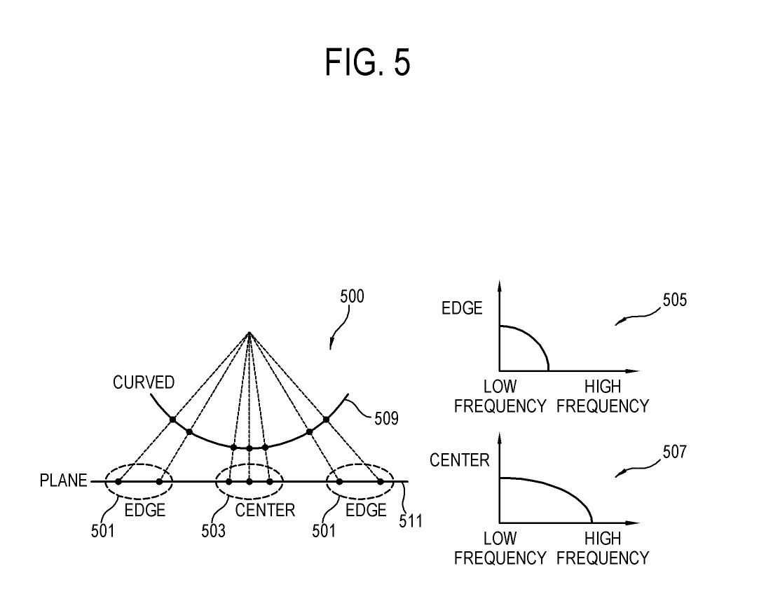

When the warping 224 according to an embodiment of the disclosure is performed, for example, when an image is enlarged or reduced, or when an image is subjected to the curved-to-plane mapping, the pixel density and the like characteristics of the image is changed. FIG. 4 illustrates an example that the pixel density is varied depending on the enlargement or reduction of the image, and FIG. 5 illustrates an example that the pixel density is varied depending on the curved-to-plane mapping of the image. As shown in FIG. 4, when an image 401 or 407 is reduced or enlarged, a space between pixels 400 or 405 is changed to thereby change the pixel density of the image 401 or 407. Meanwhile, referring to FIG. 5, when a curved image 509 is converted into a plane image 511, the pixel density is relatively high in a center portion 503 but relatively low in an edge portion 501, i.e. the pixel density is varied depending on the areas. When the pixel density is changed, the frequency characteristics 403, 409, 505 and 507 of the image are also changed. Specifically, when the image 401 is reduced, the image has a high frequency characteristic 403 because the pixel density increases. When the image 407 is enlarged, the image has a low frequency characteristic 409 because the pixel density decreases. Meanwhile, when the image 509 is converted into a plane image 511, the image has a high frequency characteristic 505 in the certain portion 503 but a low frequency characteristic 507 in the edge portion 501.

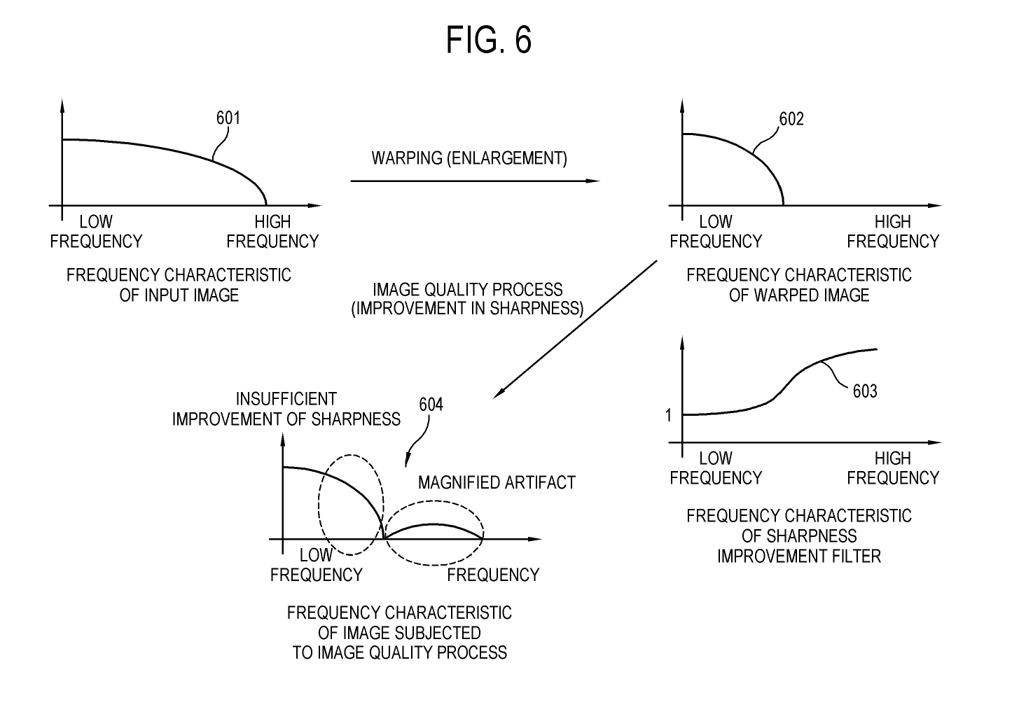

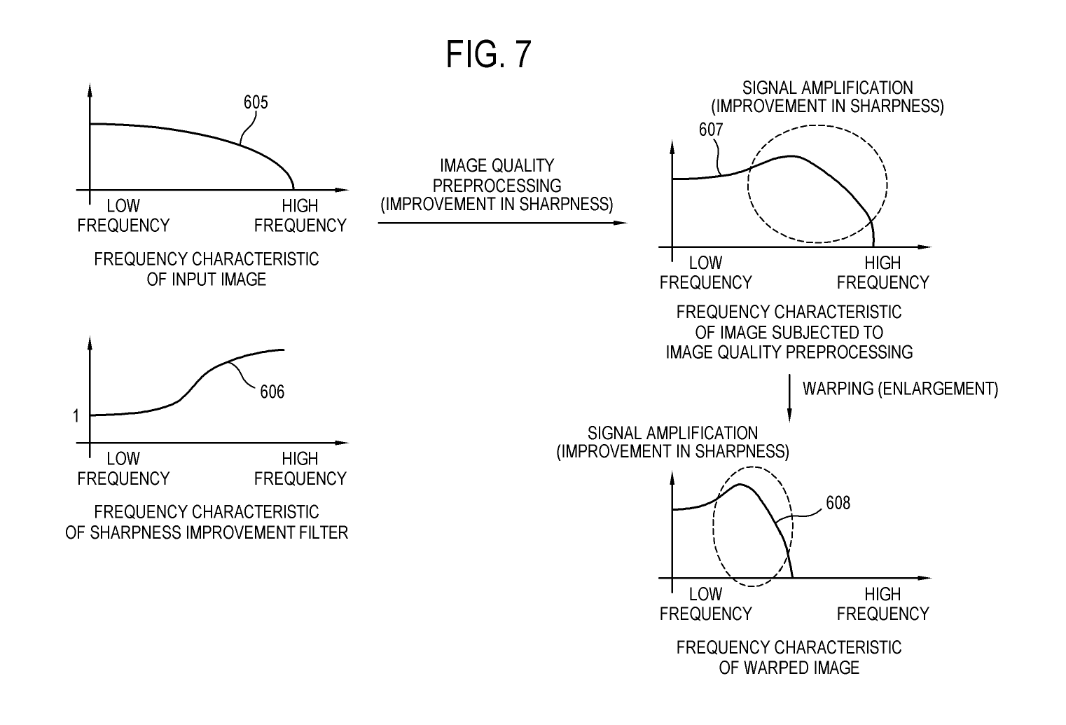

Meanwhile, as described above, the image-quality preprocessing 223 for improving the sharpness, reducing noise, etc. affects the frequency characteristics of the image. FIGS. 6 and 7 illustrate warping and image quality (pre-) processing, and frequency characteristics of an image. First, FIG. 6 shows the frequency characteristics of the image according to the related art when the image quality process is performed after the warping. In FIGS. 6 and 7, improvement in sharpness using a high-pass filter is given as an example of the warping, and enlargement of an image is given as an example of the image quality (pre-) processing, but the warping and the image quality (pre-) processing are not limited to these examples.

Referring to FIG. 6, ‘601’ indicates the frequency characteristics of the input image. When the warping such as enlargement is performed with regard to the input image, the image subjected to the warping has the frequency characteristics as indicated by ‘602’. That is, the image subjected to the warping such as the enlargement has a low frequency characteristic. Next, when the image quality process is performed by applying a sharpness improvement filter having a frequency characteristic as indicated by ‘603’ to the image subjected to the warping, the image subjected to the image quality process has a frequency characteristic as indicated by ‘604’. That is, in the case of the image quality process such as the sharpness improvement process, there is not much change in a low frequency component, but noise of a high frequency component is amplified. Therefore, when the image quality process is performed after applying the warping to the input image, the image quality may not be properly improved as originally intended because the sharpness is insufficiently improved and an artifact such as noise is amplified.

To solve this problem, the display apparatus 1 according to an embodiment of the disclosure first performs the image-quality preprocessing for changing a specific frequency component before performing the warping. Referring to FIG. 7, ‘605’ indicates a frequency characteristic of an input image. When the image-quality preprocessing is performed by applying a sharpness improvement filter having a frequency characteristic (for increasing a high frequency component) as indicated by ‘606’ to the input image, the image subjected to the image-quality preprocessing has the frequency characteristic as indicated by ‘607’. That is, the image subjected to the image-quality preprocessing is increased in the high frequency component and thus improved in the sharpness. Next, when the warping such as the enlargement is applied to the image subjected to the image-quality preprocessing, the warped image has a frequency characteristic as indicated by ‘608’. That is, because the image has a low frequency characteristic as a result of performing the warping such as the enlargement, the characteristic of the image improved in the sharpness is maintained without making the artifact based on the noise of the high frequency component. Accordingly, the display apparatus 1 according to an embodiment of the disclosure previously changes the specific frequency component of the image to improve the image quality prior to the warping by which the pixel density is changed, thereby improving the image quality while preventing the image from distortion.

In the embodiment illustrated in FIG. 2, the image subjected to the image-quality preprocessing 223 is converted into the spherical image 203 and then converted again into the plane image 205. However, the disclosure is not limited to this embodiment. Alternatively, the display apparatus 1 applies to another warping to the image subjected to the image-quality preprocessing 223 without making the spherical image 203, thereby directly generating the plane image 205.

Meanwhile, referring back to FIG. 2, the display apparatus 1 may perform image quality postprocessing 225 with regard to the plane image 205, thereby outputting or displaying the output image 207 (refer to ‘226’ of FIG. 2). According to an embodiment of the disclosure, the image quality postprocessing 225 is given as an example of a third image process for changing the whole characteristics of the image according to the disclosure. The whole characteristics of the image refer to the characteristics of the image represented by a representative value (e.g. an average value) of the entire image displayed on the screen, such as color, brightness, contrast, etc. According to an embodiment of the disclosure, the image quality postprocessing 225 may for example include a process for changing the color, brightness, contrast, etc. of the plane image 205.

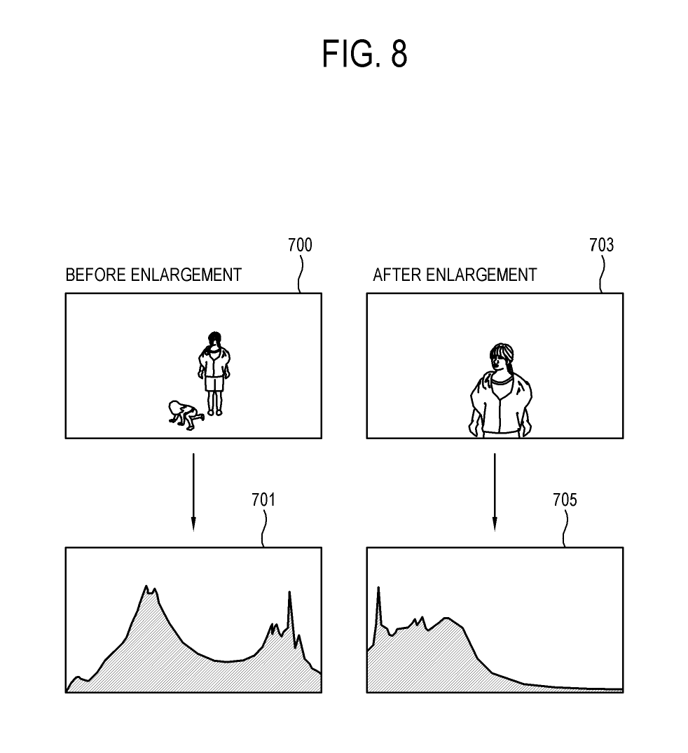

According to an embodiment of the disclosure, an area of the output image 207 is determined based on selection of the area-of-interest 211, and the area of the output image 207 is also varied depending on the change of the area-of-interest 211. When the area of the image is changed, the whole characteristics of the image is changed. FIG. 8 illustrates the change in the whole characteristics based on the area change of the image. In FIG. 8, enlargement of the image is given as an example of the area change in the image, but the area change of the disclosure is not limited to this example but may be applied to the reduction, viewpoint change, etc. of the image. ‘701’ and ‘705’ respectively indicate histograms 701 and 705 of images 700 and 703 before and after the enlargement. The image histograms 701 and 705 show the whole characteristics of the image, in which the abscissa indicates the brightness of a pixel and the ordinate indicates frequencies that the brightness of the pixel appears in the images 700 and 703. As shown therein, the area is changed as the image 700, 703 is enlarged, and the image histograms 701 and 705 showing the whole characteristics are also varied. That is, it will be appreciated that the whole characteristics are varied depending on the enlargement or the like area change of the image 700, 703.

According to an embodiment of the disclosure, the display apparatus 1 performs the image quality postprocessing 225 for changing the whole characteristics of the image after performing the warping 224. The warping 224 is performed with regard to the area-of-interest 211, the image 205 subjected to the warping 224 is an image of which the area change is completed. When the image quality process for changing the whole characteristics is performed before the warping 224, the area of the image is changed by the following warping 224 and therefore there is a problem that the whole characteristics based on the previously performed image quality process are changed again. Therefore, when the image quality postprocessing 225 for changing the whole characteristics is performed with regard to the image 205, of which the area change is completed, after the warping 224, the problem that the whole characteristics are changed again as above does not arise. Therefore, when the display apparatus 1 according to an embodiment of the disclosure changes the whole characteristics of the image to improve the image quality, it is possible to solve the problem that the image is distorted by the change of the area.

The display apparatus 1 shown in FIG. 2 outputs the output image 207 after applying the image quality postprocessing 225 to the image 205 subjected to the warping 224, but this is merely an example of the display apparatus according to the disclosure. For example, a display apparatus according to another embodiment of the disclosure may directly output the image 205 without applying the image quality postprocessing 225 to the image 205 subjected to the warping 224, or may output an image by applying another image process to the image 205 subjected to the warping 224.

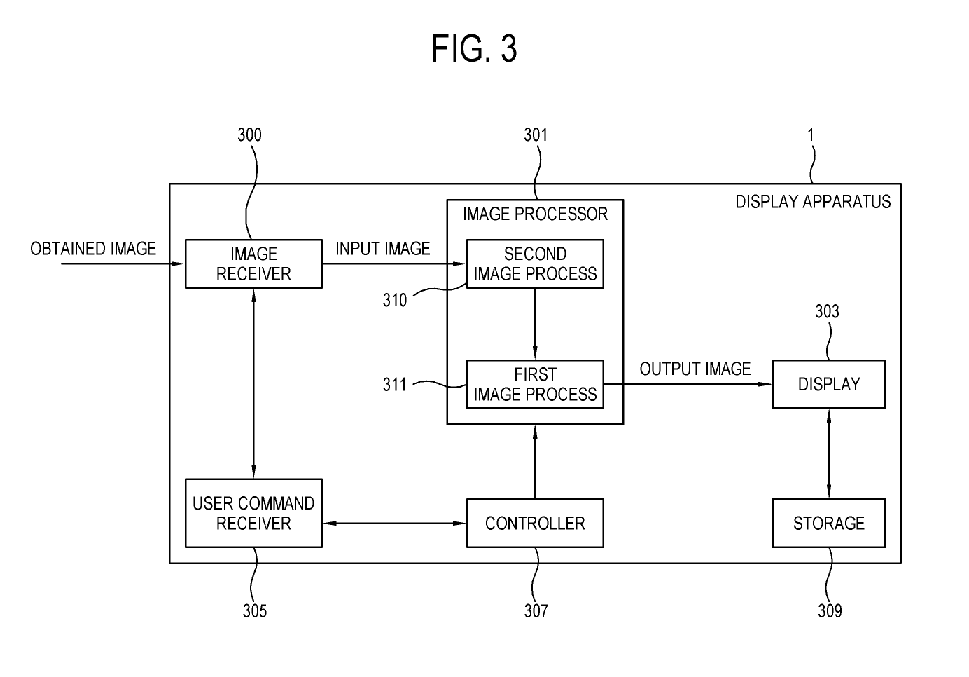

Below, the configuration of the display apparatus 1 according to an embodiment of the disclosure will be described in more detail. FIG. 3 is a block diagram of a display apparatus 1 according to an embodiment of the disclosure. The display apparatus 1 according to an embodiment of the disclosure includes an image processor 301, a display 303, and a controller 307. The display apparatus 1 according to an embodiment of the disclosure may further include at least one of an image receiver 300, a user command receiver 305, or a storage 309. The configuration of the display apparatus 1 according to an embodiment of the disclosure shown in FIG. 3 is merely an example, and a display apparatus according to an embodiment of the disclosure may have another configuration besides the configuration shown in FIG. 3. That is, a display apparatus according to an embodiment of the disclosure may include another element in addition to the configuration shown in FIG. 3, or may exclude one of the elements from the configuration shown in FIG. 3.

The image receiver 300 receives an image signal including the input image 200. The image receiver 300 may include a tuner for receiving an image signal. The tuner may be tuned to one channel selected by a user among a plurality of channels and receive a broadcast signal. The image receiver 300 may receive an image signal from an image processing apparatus such as a set-top box, a digital versatile disc (DVD) player, a personal computer, etc., from a mobile device such as a smart phone, or a server through the Internet.

The image receiver 300 may include a communicator for communicating with an external apparatus to receive the input image 200. The communicator may be variously actualized by the type or the like of the external apparatus or the display apparatus 1. For example, the communicator includes a connection unit for wired communication, and the connection unit may include at least one connector or terminal corresponding to standards such as high definition multimedia interface (HDMI), HDMI-consumer electronics control (CEC), USB, Component, etc. by which signal/data is transmitted/received. The communicator may perform wired communication with a plurality of servers through a wired local area network (LAN).

The communicator may be actualized by various other communication methods besides the connection unit including the connector or terminal for the wired connection. For example, the communicator may include a radio frequency (RF) circuit for transmitting and receiving an RF signal to perform wireless communication with the external apparatus, and may be configured to perform one or more communications among Wi-fi, Bluetooth, ZigBee, ultra-wide band (UWB), wireless USB, and near field communication (NFC).

The user command receiver 305 receives a user input and transmits the user input to the controller 307. The user command receiver 305 may be variously actualized in accordance with the types of the user input, and may for example actualized by a menu button provided on an outer side of the display apparatus 1, a remote control signal receiver for receiving a remote control signal of the user input from a remote controller, a touch screen provided on the display 303 and receiving a user's touch input, a camera for sensing a user's gesture input, a microphone for recognizing a user's voice input, etc.

The storage 309 is configured to store various pieces of data of the display apparatus 1. The storage 309 may include a nonvolatile memory (e.g. a writable read only memory (ROM)), in which data is retained even though power supplied to the display apparatus 1 is cut off and changes are reflected. That is, the storage 309 may include one of a flash memory, an erasable programmable ROM (EPROM), or an electrically EPROM (EEPROM). The storage 309 of the display apparatus 1 may further include a volatile memory such as a dynamic random access memory (DRAM) or a static RAM (SRAM), of which reading or writing speed is higher than that of the nonvolatile memory.

The image processor 301 performs an image process with regard to an image signal received through the image receiver 300 and outputs the image signal subjected to the image process to the display 303, thereby displaying an output image (see ‘207’ in FIG. 2) on the display 303. The image processor 301 may perform a second image process 310 and a first image process 311 as described above under control of the controller 307. In addition, the image processor 301 may further perform a third image process as described above under the control of the controller 307. According to an embodiment of the disclosure, the image processor 301 may be provided as a single element and perform all of the second image process 310, the first image process 311, and the third image process.

Alternatively, the image processor 301 may be actualized as an individual element for performing at least one among the second image process 310, the first image process 311 or the third image process. The image processor 301 may further perform at least one image process such as scaling for adjusting a resolution of an image, etc. besides the second image process 310, the first image process 311 and the third image process. The image processor 301 may be actualized by one or more hardware and/or software modules or combination thereof.

The display 303 displays the output image (see ‘207’ in FIG. 2) generated as the image processor 301 performs the first image process and the second image process with regard to the input image. There are no limits to the types of the display 303, and the display 303 may for example be actualized by various display types such as liquid crystal, plasma, a light-emitting diode (LED), an organic light-emitting diode (OLED), a surface-conduction electron-emitter, a carbon nano-tube (CNT), nano-crystal, etc.

In a case of an LCD type, the display 303 includes a liquid crystal display panel, a backlight unit for illuminating the liquid crystal display panel, a panel driving substrate for driving the liquid crystal display panel, etc. The display 303 may be actualized by a self-emissive OLED panel without the backlight unit.

The controller 307 performs control for operating general elements of the display apparatus 1. The controller 307 may include a control program for performing such control operation, a nonvolatile memory in which the control program is installed, a volatile memory in which at least a part of the installed control program is loaded, at least one microprocessor or central processing unit (CPU) for executing the loaded control program. The control program may include a program(s) actualized by at least one of a basic input/output system (BIOS), a device driver, an operating system, a firmware, a platform, or an application program (or application). According to an embodiment, the application program may be previously installed or stored in the display apparatus 1 when the display apparatus 1 is manufactured, or may be installed in the display apparatus 1 based on data received from the outside when it is used. The data of the application may for example be downloaded from an external server such as an application market to the display apparatus 1.

According to an embodiment, the controller 307 controls the image receiver 300 to receive the input image 200 generated based on a plurality of images captured through the camera 2 including at least one lens. The controller 307 controls the image processor 301 to output the output image 207 by performing the first image process 311 for changing the pixel density with regard to the area-of-interest 211 of the input image 200, and performing the second image process 310 for changing a specific frequency component before the first image process 311. The controller 307 selects the area-of-interest 211 in response to a user input received through the user command receiver 305. The controller 307 may control the image processor 301 to additionally perform the third image process with regard to the image 205 subjected to the first image process 311. In the display apparatus 1 shown in FIG. 3, the image processor 301 and the controller 307 are separately provided, but this is merely an example. In a display apparatus according to an alternative embodiment of the disclosure, an image processor and a controller may be integrated. For example, one or more processors may be used to one or more software to perform the function of the image processor and the function of the controller.

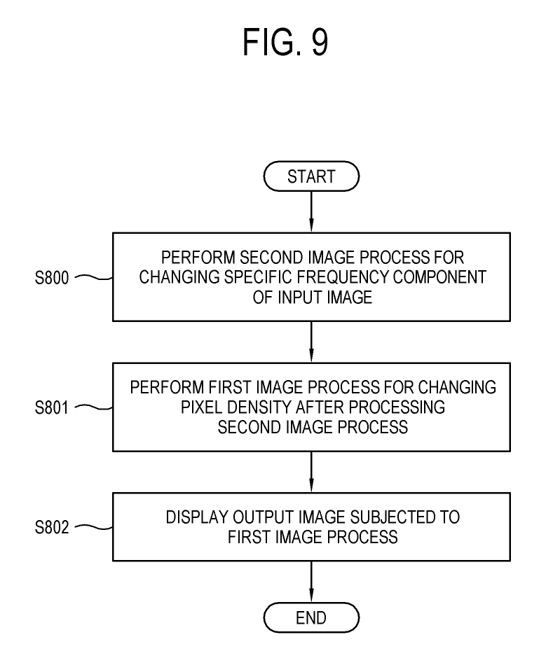

FIG. 9 is a control flowchart of the display apparatus according to an embodiment of the disclosure. First, at operation S800, the image processor 301 performs the second image process for changing a specific frequency component of the input image (see ‘200’ in FIG. 2). Then, at operation S801, the image processor 301 performs the first image process for changing the pixel density after the second image process. Then, at operation S803, the display 303 displays the output image 207 subjected to the first image process. According to an additional embodiment, the image processor 301 may perform the third image process for changing the whole characteristics of the image after the first image process, thereby displaying the output image 207.

1. A display apparatus comprising:
an image receiver configured to receive an omnidirectional image;
an image processor configured to perform an image process with regard to the received image;
a display configured to display an image based on the image process; and
a controller configured to control the image processor to perform a second image process for changing a characteristic of a certain area of the image and to perform a first image process for changing pixel density.

2. The display apparatus according to claim 1, wherein the second image process comprises a filtering process for one of a high frequency component and a low frequency component of the image.

3. The display apparatus according to claim 1, wherein the controller controls the image processor to further perform a third image process for changing whole characteristics of the image subjected to the first image process.

4. The display apparatus according to claim 1, further comprising a user command receiver configured to receive a user input,
wherein the controller controls the image processor to select the certain area of the image based on the user input.

5. The display apparatus according to claim 4, wherein the first image process comprises a process for converting the received image into a spherical image.

6. The display apparatus according to claim 5, wherein the first image process comprises a process for converting the spherical image into a plane image.

7. The display apparatus according to claim 1, wherein the first image process comprises a process for enlarging or reducing the certain area of the image.

8. The display apparatus according to claim 1, wherein the image receiver comprises a camera comprising at least one lens configured to omnidirectionally capture an image.

9. A method of controlling a display apparatus, the method comprising:
receiving an omnidirectional image;
performing an image process with regard to the received image; and
displaying an image based on the image process, and
the performing of the image process comprising:
performing a second image process for changing a characteristic of a certain area of the image; and
performing a first image process for changing pixel density after the second image process.

10. The method according to claim 9, wherein the second image process comprises a filtering process for one of a high frequency component and a low frequency component of the image.

11. The method according to claim 9, wherein the performing of the image process further comprises performing a third image process for changing whole characteristics of the image subjected to the first image process.

12. The method according to claim 9, further comprising:
receiving a user input; and
selecting the certain area of the image base on the user input.

13. The method according to claim 9, wherein the first image process comprises a process for converting the received image into a spherical image.

14. The method according to claim 13, wherein the first image process comprises a process for converting the spherical image into a plane image.

15. The method according to claim 9, wherein the first image process comprises a process for enlarging or reducing the certain area of the image.
